(19) United States
(12) Patent Application Publication
(10) Pub. No.: US 2006/0121776 A1
(43) Pub. Date: Jun. 8, 2006

(54) Electric connector

(75) Inventor: Chi-Neng Kao, Shin Juang City (TW)

Correspondence Address: PAI PATENT & TRADEMARK LAW FIRM, 1001 FOURTH AVENUE, SUITE 3200, SEATTLE, WA, 98154, US

(73) Assignee: Unicorn Electronics Components Co., Ltd.

(21) Appl. No.: 11/006,860

(22) Filed: Dec. 8, 2004

(51) Int. Cl. H01R 12/24

(52) U.S. Cl. 439/495

(57) ABSTRACT

An electric connector for connecting a flexible circuit board to a circuit substrate is disclosed, comprising a connector body, which has smoothly arched positioning grooves and locating notches, a swinging cover, which is coupled to the connector body for holding down a flexible circuit board on the connector body and has arched protruding bearing portions and locating butts corresponding to the smoothly arched positioning grooves and locating notches of the connector body and a plurality of rod members corresponding to the terminal slots of the connector body, and terminals, which are mounted in the connector body, each comprising a contact arm for contacting the inserted flexible circuit board, a support arm for holding down the inserted flexible circuit board, a hooked portion protruded from the support arm for hooking on one rod member of the connector body, and a bonding leg for bonding to a circuit substrate.

### BACKGROUND OF THE INVENTION

1. Field of the Invention

The present invention relates to an electric connector and, more particularly, to an electric connector for connection between a flexible circuit board and a printed substrate.

2. Description of the Related Art

FIGS. 12˜14 show an electric connector for connection between a flexible circuit board and a printed substrate according to the prior art. This structure of electric connector comprises a connector body 80 and a swinging cover 90. The connector body 80 holds a set of terminals on the inside. The swinging cover 90 has two round pins 91 symmetrically disposed at two sides and respectively pivoted to the connector body 80. After a flexible circuit board is set in between the connector body 80 and the swinging cover 90, the swinging cover 90 is closed on the connector body 80 to hold down the flexible circuit board, keeping the flexible circuit board in close contact with the terminals of the connector body 80 electrically.

This structure of electric connector is still not satisfactory in function. When closing the swinging cover 90 on the connector body 80 to hold down the loaded flexible circuit board, the swinging cover 90 may be forced out of place or the round pins 91 may break, resulting in improper connection between the flexible circuit board and the terminals in the connector body 80.

### BRIEF SUMMARY OF THE INVENTION

The present invention has been accomplished under the circumstances in view. It is one object of the present invention to provide an electric connector which is highly reliable and keeps the loaded flexible circuit board accurately in position. To achieve this and other objects of the present invention, the electric connector comprises a connector body, a swinging cover, and a set of terminals. The connector body comprises a top flexible circuit board receiving face, a back face, a plurality of terminal slots extending through the top flexible circuit board receiving face and the back face, two smoothly arched positioning grooves respectively disposed in the top flexible circuit board receiving face at two opposite lateral sides near the back, and two locating notches respectively formed in a front wall thereof and disposed at two sides of the top flexible circuit board receiving face. The swinging cover is coupled to the connector body for holding down a flexible circuit board on the top flexible circuit board receiving face. The swinging cover comprises two arched protruding bearing portions respectively fitting the smoothly arched positioning grooves of the connector body, two locating butts respectively insertable into the locating notches of the connector body, and a plurality of rod members corresponding to the terminal slots of the connector body. The terminals are respectively mounted in the terminal slots of the connector body, each comprising a contact arm suspending in one terminal slot in the top flexible circuit board receiving face of the connector body and terminating at a protruding contact portion for the contact of a flexible circuit board, a support arm spaced above the contact arm, the support arm having a recessed receiving portion corresponding to the protruding contact portion and a hooked portion for hooking on one rod member of the connector body, and a bonding leg extending out of the back face of the connector body for bonding to a circuit substrate.

### BRIEF DESCRIPTION OF THE DRAWINGS

FIG. 1 is an exploded view of an electric connector according to the present invention.

FIG. 2 is an elevational assembly view of the electric connector according to the present invention.

FIG. 3 is an exploded view in section corresponding to line 3-3 of FIG. 2.

FIG. 4 is a sectional assembly view of FIG. 3.

FIG. 5 is a sectional view taken along line 5-5 of FIG. 2.

FIG. 6 corresponds to FIG. 5 but showing terminals inserted into the connector body.

FIG. 7 corresponds to FIG. 6 showing the terminals set into position.

FIG. 8 corresponds to FIG. 7 but showing the swinging cover opened.

FIG. 9 corresponds to FIG. 8 but showing the flexible circuit board inserted into the connector body between the top flexible circuit board receiving face of the connector body and the swinging cover.

FIG. 10 corresponds to FIG. 9 but showing the swinging cover turned downwards after insertion of the flexible circuit board.

FIG. 11 corresponds to FIG. 10 but showing the swinging cover closed.

FIG. 12 is an elevational view of an electric connector according to the prior art.

FIG. 13 corresponds to FIG. 12 but showing the swinging cover opened.

FIG. 14 is top view and side view of the swinging cover of the electric connector of FIG. 12.

### DETAILED DESCRIPTION OF THE PREFERRED EMBODIMENT

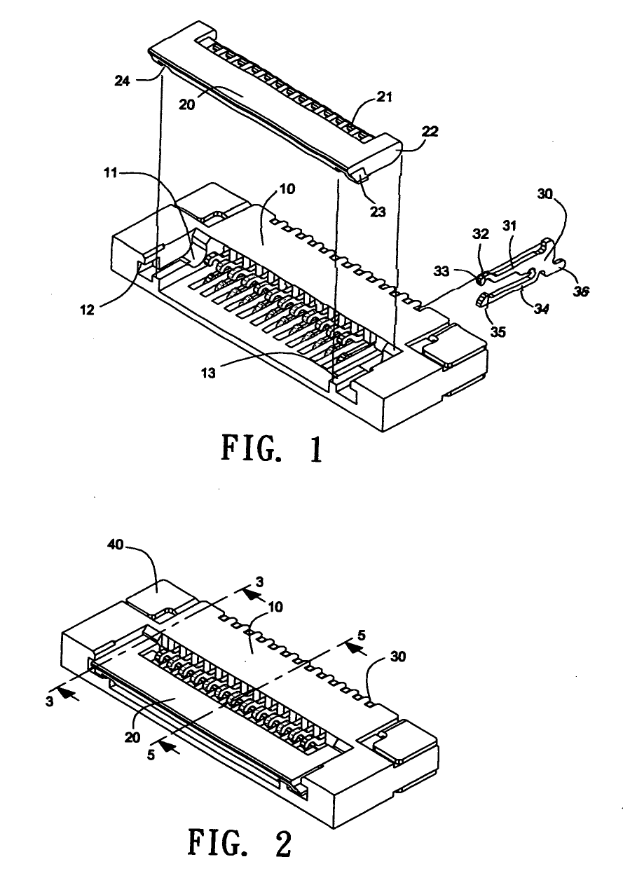

Referring to FIGS. 1 and 2, an electric connector in accordance with the present invention is shown comprised of a connector body 10, a swinging cover 20, and a set of terminals 30.

The connector body 10 has a top flexible circuit board receiving face, a back face, a plurality of terminal slots extending through the top flexible circuit board receiving face and the back face, two smoothly arched positioning grooves 11 respectively disposed in the top flexible circuit board receiving face at two opposite lateral sides near the back, two locating notches 12 respectively formed in the front wall and disposed at two sides of the top flexible circuit board receiving face, and two ribs 13 upwardly protruded from the top flexible circuit board receiving face and respectively forwardly extending from the smoothly arched coupling grooves 11. The swinging cover 20 comprises two arched protruding bearing portions 22 respectively fitting the smoothly arched positioning grooves 11 of the connector body 10, two locating butts 23 respectively insertable into the locating notches 12 of the connector body 10, rod members 21 corresponding to the terminal slots in the connector body 10, and a plurality of bottom grooves 24 adapted to receive the ribs 13 of the connector body 10.

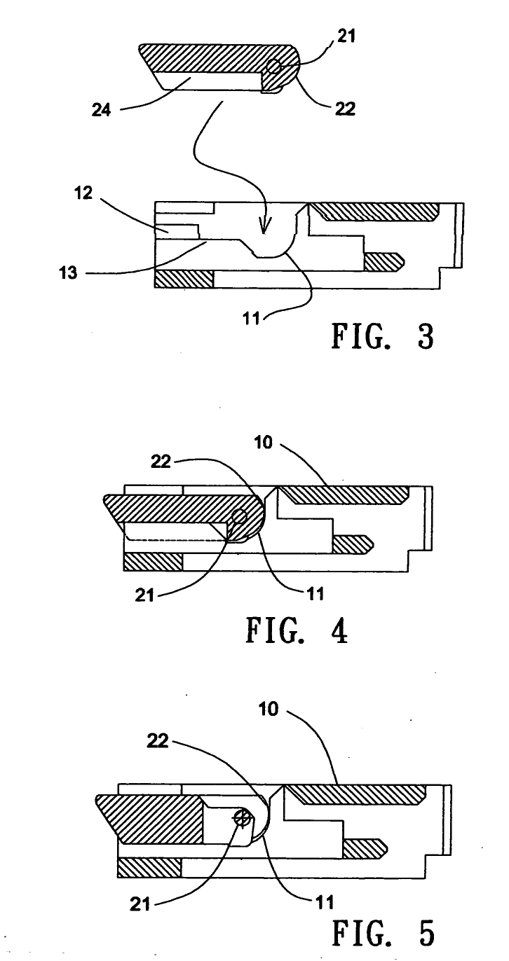

Referring to FIGS. 3˜5, the swinging cover 20 is attached to the connector body 10 from the top to force the bottom grooves 24 into engagement with the ribs 13 respectively, and then the swinging cover 20 is pushed backwards to engage the locating butts 23 into the locating notches 12. At this time, the swinging cover 20 is securely engaged to the connector body 10.

The terminals 30 are respectively mounted in the terminal slots of the connector body 10, each comprising a contact arm 34 suspending in one terminal slot in the top flexible circuit board receiving face of the connector body 10 and terminating at a protruding contact portion 35 for the contact of the flexible circuit board, a support arm 31 spaced above the contact arm 34 and terminating at a recessed receiving portion 32 corresponding to the protruding contact portion 35 and then a hooked portion 33, and a bonding leg 36 extending out of the back face of the connector body 10 for bonding to the circuit substrate.

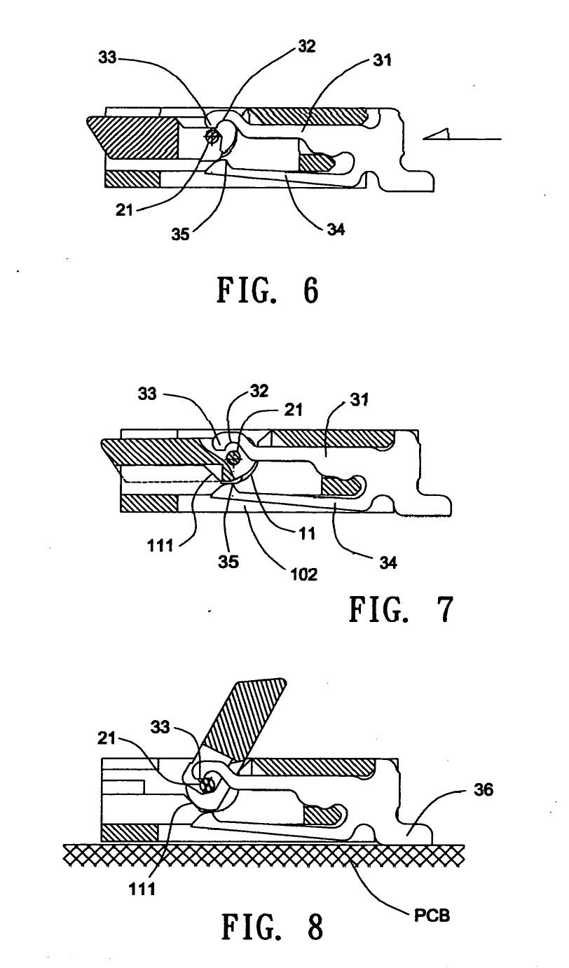

Referring to FIGS. 6˜8, the terminals 30 are respectively inserted into the terminal slots of the connector body 10 from the back face to force the respective hooked portions 33 over the rod members 21 of the swinging cover 20. When assembled, the rod members 21 of the swinging cover 20 are held between the hooked portions 33 of the terminals 30 and one sloping edge 111 of each rib 13 of the connector body 10, allowing the swinging cover 30 to be moved horizontally forwards/backwards to engage the locating butts 23 into the locating notches 12 or to disengage the locating butts 23 from the locating notches 12. After disengagement of the locating butts 23 from the locating notches 12, the swinging cover 20 can then be turned relative to the connector body 20 between the close position and the open position.

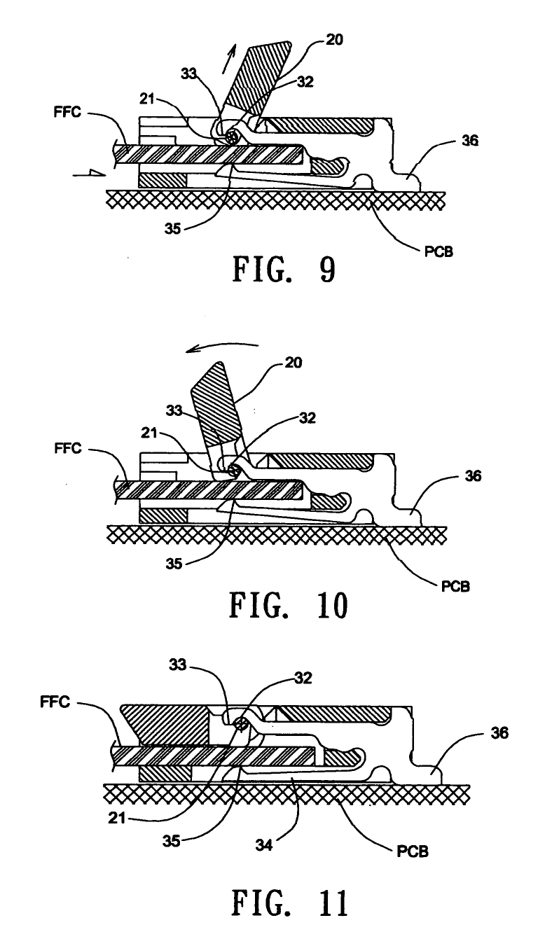

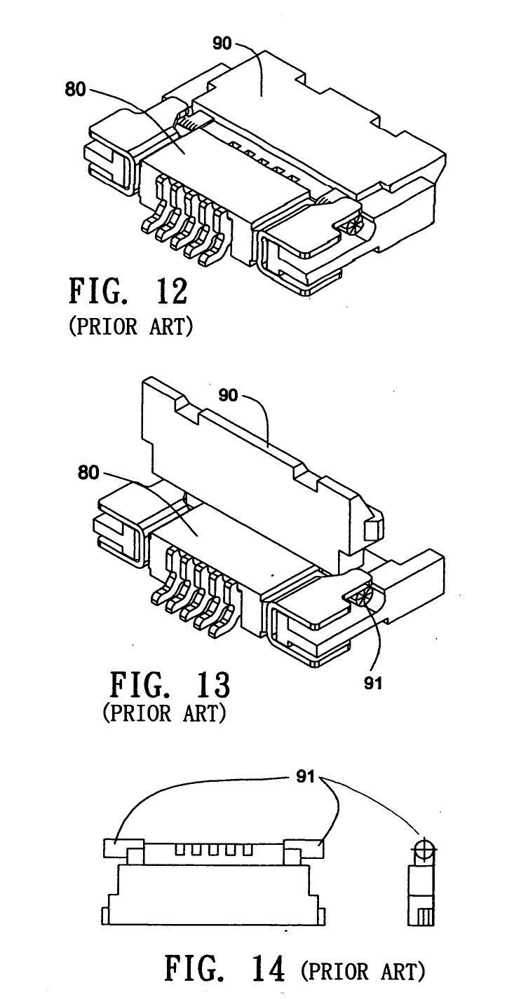

Referring to FIGS. 9˜11, after the swinging cover 20 has been opened to the extent as shown in FIG. 9, the flexible circuit board FFC is inserted into the electric connector between the top flexible circuit board receiving face of the connector body 10 and the swinging cover 20 to lift the swinging cover 20 upwards and to further force the rod members 21 of the swinging cover 20 into engagement with the hooked portions 33 of the terminals 30, and then the swinging cover 20 is turned downwards from the open position to the close position as shown in FIGS. 10 and 11. At this time, the flexible circuit board FFC is engaged in between the contact arm 34 and support arm 31 of each terminal 30 and securely retained between the recessed receiving portion 32 and protruding contact portion 35 of each terminal 30.

A prototype of electric connector has been constructed with the features of FIGS. 1˜11. The electric connector functions smoothly to provide all of the features discussed earlier.

Although a particular embodiment of the invention has been described in detail for purposes of illustration, various modifications and enhancements may be made without departing from the spirit and scope of the invention.

The invention claimed is:

1. An electric connector comprising.
a connector body, said connector body comprising a top flexible circuit board receiving face, a back face, a plurality of terminal slots extending through said top flexible circuit board receiving face and said back face, two smoothly arched positioning grooves respectively disposed in said top flexible circuit board receiving face at two opposite lateral sides near the back, and two locating notches respectively formed in a front wall thereof and disposed at two sides of said top flexible circuit board receiving face;
a swinging cover coupled to said connector body for holding down a flexible circuit board on said top flexible circuit board receiving face, said swinging cover comprising two arched protruding bearing portions respectively fitting said smoothly arched positioning grooves of said connector body, two locating butts respectively insertable into said locating notches of said connector body, and a plurality of rod members corresponding to said terminal slots of said connector body; and
a plurality of terminals respectively mounted in the terminal slots of said connector body, said terminals each comprising a contact arm suspending in one terminal slot in said top flexible circuit board receiving face of said connector body and terminating at a protruding contact portion for the contact of a flexible circuit board, a support arm spaced above said contact arm, said support arm having a recessed receiving portion corresponding to said protruding contact portion and a hooked portion for hooking on one rod member of said connector body, and a bonding leg extending out of said back face of said connector body for bonding to a circuit substrate.

2. The electric connector as claimed in claim 1, wherein said connector body further comprises a plurality of ribs upwardly protruded from said top flexible circuit board receiving face, and said swinging cover further comprises a plurality of bottom grooves adapted to accommodate said plurality of ribs, respectively.
